(19) United States
(12) Patent Application Publication
(10) Pub. No.: US 2026/0228011 A1
(43) Pub. Date: Aug. 6, 2026

(54) MULTI-VECTOR RENAMING TO AVOID BANK WRITE CONFLICTS

(71) Applicant: QUALCOMM Incorporated, San Diego, CA (US)

(72) Inventors: Vinay PATEL, Stouffville (CA); Luca MARONCELLI, Austin, TX (US); Yiran HUANG, Cambridge (GB)

(21) Appl. No.: 19/232,644

(22) Filed: Jun. 9, 2025

Related U.S. Application Data
(63) Continuation of application No. 19/046,323, filed on Feb. 5, 2025.

(51) Int. Cl. G06F 9/38; G06F 9/30

(52) U.S. Cl. CPC G06F 9/384; G06F 9/3012

(57) ABSTRACT

Techniques proposed herein may dynamically map architectural registers that instructions use to a set of physical registers from different rename banks, rather than using the same architectural registers as specified in an instruction set architecture (ISA). For example, each architectural register that the instructions use may be renamed to a physical register from a different rename bank. A rename bank refers to a set of physical registers that are used to store values for the instructions. A processor keeps track of the renaming of the architectural registers in a table.

### CROSS-REFERENCE TO RELATED APPLICATION

This application is a continuation of U.S. patent application Ser. No. 19/046,323, filed Feb. 5, 2025, which is expressly incorporated herein by reference in its entirety.

### BACKGROUND

### Field of the Disclosure

Aspects of the present disclosure relate to techniques for managing register renaming.

### Description of Related Art

A central processing unit (CPU) is a primary component of a computer that performs most of processing. The CPU is often referred to as a brain of the computer because the CPU handles execution of instructions from programs, processes data, and controls other parts of the computer.

CPUs come in various designs and architectures, with different numbers of processing cores, clock speeds, and other features, which all affect performance.

A processing core is a component of the CPU that is capable of executing instructions independently. For example, the processing core is a single processing unit within the CPU that can execute its own thread of instructions. The CPU may include multiple processing cores, which allows the processing cores to execute multiple tasks concurrently or in parallel, significantly improving performance for multi-threaded applications or multi-tasking environments.

Registers are small, high-speed storage locations inside the CPU that are used to hold data temporarily during processing. They are much faster than a main system memory, allowing the CPU to quickly access and manipulate data. There are different types of registers in the CPU.

General-purpose registers hold temporary data that the CPU is working with during program execution. For example, in a simple addition operation, operands (values) and result might all be held in the general-purpose registers.

Special-purpose registers are used for specific control functions. The special-purpose registers include program counter (PC) that holds an address of a next instruction to be executed, stack pointer (SP) points to a current top of a stack in memory, instruction register (IR) that holds a current instruction being executed, and status registers that hold flags indicating the status of the CPU (e.g., zero, carry, overflow).

Floating point registers are specialized registers used to store floating-point numbers (used for decimal-based calculations).

Control registers may control various aspects of the CPU's operation, such as memory management or interrupt handling.

In modern processors, multiple instructions can be processed simultaneously, and executed out of order, to make efficient use of CPU resources (e.g., by avoiding stalling execution of a later instruction because an earlier instruction is waiting for data). However, out of order execution can lead to problems when multiple instructions want to use the same register. To mitigate these issues, the CPUs use register renaming. Register renaming assigns temporary “physical” register names to each instruction, effectively removing this dependency by allowing multiple instructions to write to the same logical register without conflict.

In this manner, out of order execution and register renaming allow instructions to be executed in a different order than the program sequence while maintaining data dependencies, increasing instruction-level parallelism and reducing pipeline stalls.

### SUMMARY

One aspect provides a method for obtaining a sequence of instructions that includes at least one instruction that has at least one operand that references multiple architectural register tags, renaming the multiple architectural register tags to physical register tags organized in multiple rename banks, and dispatching the instruction for execution after the renaming.

Other aspects provide: an apparatus operable, configured, or otherwise adapted to perform the aforementioned method as well as those described elsewhere herein; a non-transitory, computer-readable media comprising instructions that, when executed by one or more processors of an apparatus, cause the apparatus to perform the aforementioned method as well as those described elsewhere herein; a computer program product embodied on a computer-readable storage medium comprising code for performing the aforementioned method as well as those described elsewhere herein; and an apparatus comprising means for performing the aforementioned method as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system-on-chip (SoC), in accordance with certain aspects of the present disclosure.

FIG. 2 depicts example central processing unit (CPU) system, in accordance with certain aspects of the present disclosure.

FIG. 3 depicts example mapping of architectural registers to physical registers in accordance with certain aspects of the present disclosure.

FIG. 4 depicts example register rename unit configured for mapping architectural registers to physical registers organized in multiple rename banks, in accordance with certain aspects of the present disclosure.

FIG. 5 depicts assigning different architectural register tags to different rename banks, in accordance with certain aspects of the present disclosure.

FIG. 6 depicts a method for renaming architectural register tags to physical register tags organized in multiple rename banks, in accordance with certain aspects of the present disclosure.

### DETAILED DESCRIPTION

In modern central processing units (CPUs), instructions may be executed out of order to optimize performance by utilizing available execution units efficiently. However, out of order execution can lead to situations where the instructions that use same architectural register names can end up being incorrectly sequenced and cause data hazards. These data hazards include write after read (WAR) and write after write (WAW) hazards.

The data hazards may occur when there are dependencies between the instructions that may cause potential conflicts and delays. For example, an instruction may try to read an architectural register before a previous instruction writes to it or an instruction writes to the architectural register before a previous instruction reads from it. In another example, two instructions may write to a same architectural register and thereby causing ambiguity over a final value assigned to the architectural register.

Techniques proposed herein resolve these conflicts by dynamically mapping architectural registers that instructions use to a set of physical registers from different rename banks, rather than using the same architectural registers as specified in an instruction set architecture (ISA). For example, each architectural register that the instructions use may be renamed to a physical register from a different rename bank. A rename bank refers to a set of physical registers that are used to store values for the instructions. A CPU keeps track of the renaming of the architectural registers in a table.

In some cases, the CPU may have to process instructions with multiple register destinations. A backend execution unit at the CPU may perform one operation per cycle. Physical registers may be banked and have a limited number of write ports. In such cases, if each instruction may have only one register destination, then there may not be any write conflicts, and architectural registers may be renamed to the physical registers in any manner. However, when an instruction may be writing to multiple registers, the techniques proposed herein may be applied. For example, the techniques proposed herein may ensure that a same instruction may be guaranteed to write to different physical banks (including the physical registers) and thereby avoiding potential write conflicts.

In this context, banking refers to splitting of a set of registers into groups (banks), each of which can be accessed in parallel. Using N banks increases a maximum number of accesses supported by a factor of N, allowing each bank to support fewer access ports (reducing area and energy use) for a given effective access count.

By renaming the architectural registers and mapping the architectural registers referenced in one instruction to the physical registers in different rename banks, the CPU can avoid the data hazards, and this may enable more efficient execution of the instructions. Also, since the instructions are no longer constrained by the reuse of same register names, the CPU can execute more instructions in parallel, leading to a higher throughput and better performance.

### Example System-on-Chip (SoC)

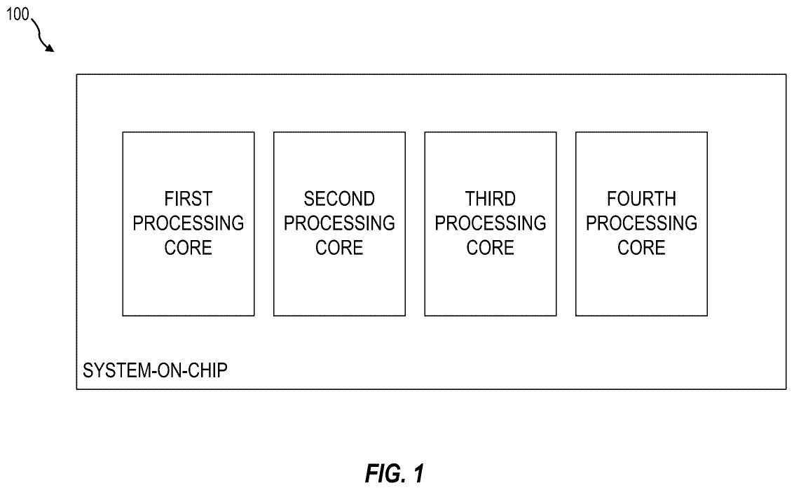

FIG. 1 depicts an example system-on-chip (SoC) 100 with multiple processing cores. A processing core is a part of a computer's central processing unit (CPU) that performs the actual work of executing instructions. Each processing core can process tasks independently or work together with other processing cores to perform more complex operations or run multiple tasks at a same time.

The multiple processing cores may include a first processing core, a second processing core, a third processing core, and a fourth processing core. The first processing core, the second processing core, the third processing core, and the fourth processing core may include at least efficiency cores and performance cores.

The SoC 100 may further include a graphics processing unit (GPU) and a neural processing unit (NPU), amongst other processing units and components on which various compute workloads may be processed (e.g., tensor processing units, application-specific integrated circuits (ASICs), digital signal processors (DSPs), and the like).

The efficiency cores and the performance cores may be processing units implementing a same processing architecture (e.g., processing units implementing advanced reduced instruction set computer (RISC) machines (ARM) or RISC-V architectures). The efficiency cores may have a lower performance (e.g., as measured by a number of operations per second that the efficiency cores can perform) than the performance cores, but may use less power than the performance cores in executing a workload.

The GPU may be a processing unit which is configured to perform large mathematical operations (e.g., matrix, vector, tensor, etc. operations) in parallel.

The NPU is a circuit configured for implementing control and arithmetic logic for executing machine learning algorithms, such as algorithms for processing artificial neural networks (ANNs), deep neural networks (DNNs), random forests (RFs), and the like. The NPU may be referred to as a neural signal processor (NSP), a tensor processing unit (TPU), a neural network processor (NNP), an intelligence processing unit (IPU), a vision processing unit (VPU), or a graph processing unit.

The NPU may be configured to accelerate performance of common machine learning tasks, such as image classification, machine translation, object detection, and various other predictive artificial intelligence models. In some examples, a plurality of NPUs may be instantiated on a single chip while in other examples such NPUs may be part of a dedicated neural-network accelerator.

The NPU may be optimized for training or inference, or in some cases configured to balance performance between both. For the NPU that is capable of performing both training and inference, two tasks may still be performed independently.

The NPU designed to accelerate training may be configured to accelerate an optimization of new artificial intelligence models, which is a highly compute-intensive operation that involves inputting an existing dataset (often labeled or tagged), iterating over a dataset, and then adjusting artificial intelligence model parameters, such as weights and biases, in order to improve artificial intelligence model performance. Generally, optimizing based on a wrong prediction involves propagating back through layers of an artificial intelligence model and determining gradients to reduce a prediction error.

The NPU designed to accelerate inference may be configured to operate on complete artificial intelligence models. The NPU may thus be configured to input a new piece of data and rapidly process this new piece through an already trained artificial intelligence model to generate an artificial intelligence model output (e.g., an inference).

Each of the processing units on the SoC 100 (e.g., the efficiency cores, the performance cores, the GPU, the NPU, and/or other processing units) may have different performance characteristics. The performance characteristics may include a power slope, a leakage power, a dynamic clock and voltage scaling points (e.g., points at which processing core clock speed and voltage draw scales upward or downward), instructions-per-clock cycle (IPC) performance levels, and the like.

The workloads executing on the SoC 100 may be defined by various characteristics which may influence how these workloads, or portions thereof, are scheduled for execution on various processing units of the SoC 100. For example, the workloads may be characterized by a number of stages (e.g., layers) in an artificial intelligence model executing on the SoC 100, a length of an input into the artificial intelligence model, data types associated with each stage or layer of the artificial intelligence model.

The processing cores may have access to shared or same execution resources associated with a resource manager to process their respective workloads. The resource manager may be a shared resource for the processing cores. The resource manager may perform register renaming (e.g., mapping architectural registers to physical registers that may be organized in multiple rename banks) to improve an efficiency of instruction execution.

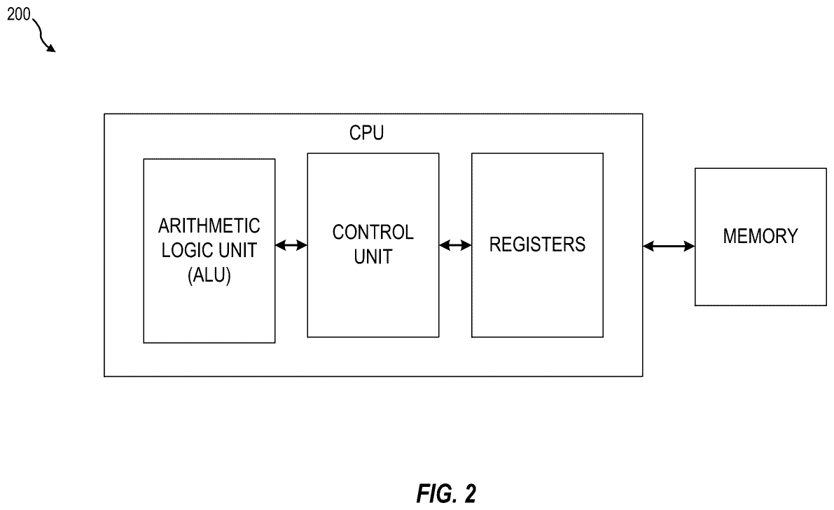

FIG. 2 depicts an example CPU system 200. The CPU system 200 includes a CPU and a memory. The memory is a storage area where the CPU temporarily stores data that is being actively used or processed. The CPU may include an arithmetic logic unit (ALU), a control unit, and registers.

The ALU may be responsible for performing arithmetic (e.g., addition, subtraction, etc.) and logical operations (AND, OR, NOT, etc.).

The control unit may coordinate and direct operations of the CPU. The control unit interprets instructions from a program and tells other components of the CPU what to do.

The registers are small, high-speed storage locations inside the CPU. The registers store data that is immediately needed for the CPU to perform its operations. The registers are used for things like holding an instruction being executed, holding intermediate results, or keeping track of the program's execution.

The CPU may further include a cache memory. The cache memory is a small, very fast memory located close to the CPU, which stores frequently accessed data to reduce the time spent fetching data from a main memory.

The CPU may further include a clock that sends regular pulses that synchronize the operations of the CPU. Each pulse corresponds to one cycle of execution.

### Example Architectural and Physical Registers

Architectural registers are registers that are visible to a programmer or a software. The architectural registers are registers that a central processing unit (CPU) instruction set architecture (ISA) defines and that the software (such as operating systems and applications) directly interacts with.

The architectural registers may hold operands and results of instructions that are executed by a CPU. The architectural registers may be used by a compiler to store variables, manage function calls, and/or perform other low-level operations.

A number of architectural registers in the CPU may be defined by an architecture of the CPU. The architectural registers may represent a state of a program, which includes things like variable values, program counters, stack pointers, and more.

In a program, an instruction may indicate (reference) architectural registers RX, as in the following example of an add instruction:
ADD R1, R2, R3
   where R1 is a destination, R2, and R3 are sources (so the instruction performs R2+R3=R1).

Physical registers are actual hardware registers inside the CPU. The physical registers are not directly visible to the software, but rather the physical registers are part of internal mechanisms of the CPU.

The physical registers may hold actual data during execution of instructions in the CPU. The physical registers may be used to store intermediate results of operations as instructions are executed, often in out-of-order execution systems.

There may be more physical registers than the architectural registers in the CPU. This excess allows for techniques like register renaming. For example, the CPU may have 100 physical registers, even though the architectural design of the CPU only exposes 16 or 32 registers to the programmer. The extra registers help to avoid conflicts during execution, enabling the CPU to keep track of multiple independent instructions at a same time.

In CPUs that implement out of order execution and register renaming, a mapping between the architectural registers and the physical registers is dynamic. The CPU uses a technique called the register renaming to map the architectural registers to the physical registers, effectively creating a one-to-many relationship where multiple architectural registers can be mapped to different physical registers during execution.

For example, an instruction wants to write to architectural register R1. R1 will be mapped to physical register P1. If another instruction wants to write to R1, the CPU can rename R1 to another physical register (e.g., physical register P2). This instruction will then write its result to P2 instead of P1. Any instructions that reads R1 between these two producing instructions will read P1. Any instruction reading from R1 after the second producing instruction will read from P2.

### Example Register Renaming

Register renaming is a technique used in central processing units (CPUs) (e.g., particularly in out of order execution systems) to eliminate data hazards and improve an efficiency of instruction execution.

In the CPUs, instructions may be executed out of order to improve performance. However, this can lead to data hazards, where one instruction depends on a result of a previous one that hasn't finished yet.

The common types of data hazards are: read-after-write (RAW) where a later instruction needs a value that a previous instruction is writing, write-after-write (WAW) where two instructions are writing to the same register which can cause conflicts, and write-after-read (WAR) where a later instruction writes to a register that a previous instruction is reading.

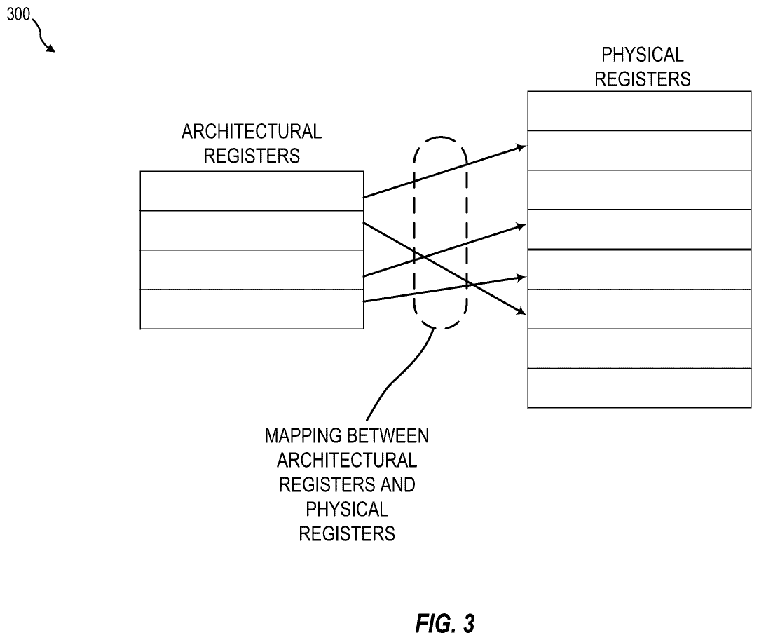

The register renaming solves problems associated with the data hazards by mapping architectural registers (e.g., registers a program sees and uses) to a larger set of physical registers within the CPU. A diagram 300 in FIG. 3 illustrates mapping of the architectural registers to the physical registers. A register map table may record the mapping from the architectural registers to the physical registers. The register map table may be a hardware structure.

The register renaming may include names of the architectural registers in the instructions being dynamically replaced with new physical register names during execution. For example, if two instructions both write to a same architectural register, the register renaming allows the CPU to assign each instruction a unique physical register, effectively avoiding conflicts. This process happens transparently during execution, and the CPU will later commit the results to a correct register in an architectural state.

When a program is executed, the CPU uses the register map table to track which physical registers correspond to which architectural registers. During execution, if an instruction needs an architectural register that is currently being written to by another instruction, the CPU can rename the architectural register by mapping it to a different physical register. This enables both instructions to execute independently without waiting for the other to finish.

By renaming registers, the CPU avoids RAW, WAR, and WAW hazards. The register renaming may also improve parallelism. For example, multiple instructions can be executed in parallel because dependencies are handled more effectively. The register renaming may increase performance. For example, since the instructions can be executed out of order without waiting for conflicts to resolve, the overall performance of the CPU improves.

In one example case there may be two instructions: register 1 (R1)=R2+R3 and R1=R4+R5. If both instructions are executed in sequence, there's a conflict because both instructions want to write to R1. Using the register renaming, the CPU may rename a first instruction to use a register R6 and a second instruction to use a register R7. These two instructions can now run simultaneously without interfering with each other.

### Example Operands

In computer architecture, operands are values or data on which operations are performed by a central processing unit (CPU). Source operands and destination operands refer to roles that the operands play in an instruction.

The source operands are the operands (data or values) that are used as input to an instruction or operation. The source operands provide the data that will be used for computation or transformation specified by the instruction. The source operand can be a register, a memory location, or an immediate value (a constant).

The destination operand is an operand that holds a result of an operation after it is performed. The destination operand is where an output or result of the operation is stored. The destination operand may be a register or a memory location, where the result of the computation will be placed.

An instruction may indicate (reference) architectural registers, as in a following example of an add instruction:
ADD R1, R2, R3
   where R1 is a destination, R2, and R3 are sources (so the instruction performs R2+R3=R1).

### Example Techniques for Renaming Architectural Register Tags to Physical Register Tags

Techniques proposed herein may dynamically map architectural registers that instructions use to a set of physical registers from different rename banks, rather than using the same architectural registers as specified in an instruction set architecture (ISA). For example, each architectural register that the instructions use may be renamed to a physical register from a different rename bank. A rename bank refers to a set of physical registers that are used to store values for the instructions. A central processing unit (CPU) keeps track of the renaming of the architectural registers in a table.

After the renaming, the instructions may dispatched for execution to a matrix processing unit (MXU) and a load store unit (LSU). The MXU may be a hardware unit designed to handle matrix computations efficiently. The MXU may be found in the CPU optimized for machine learning (ML), artificial intelligence (AI), or scientific computing. The LSU may be a functional unit within the CPU responsible for handling memory operations such as load (e.g., read data from a memory into registers) and store (e.g., write the data from the registers back to the memory).

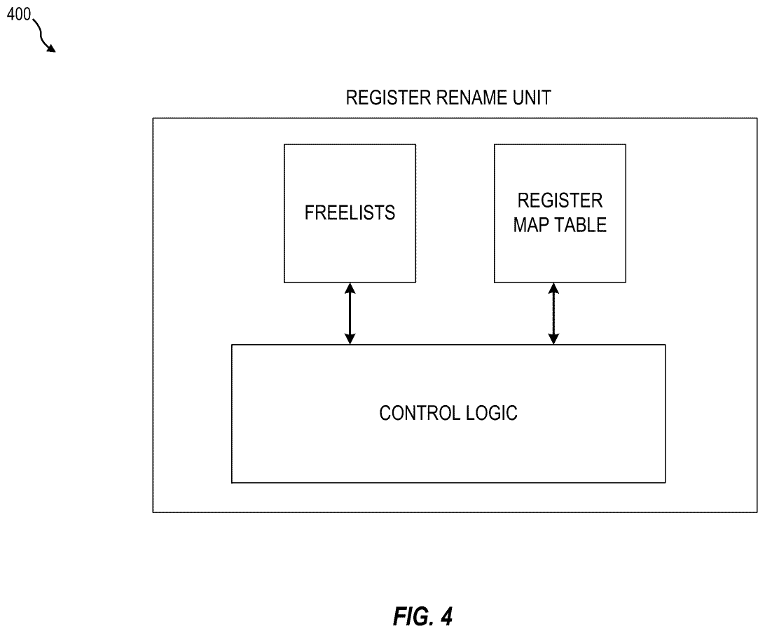

The techniques proposed herein may be further understood with reference to FIG. 4-FIG. 6.

FIG. 4 depicts example register rename unit 400. The register rename unit 400 may be part of a CPU execution pipeline, such as in out of order execution processors.

The CPU may receive one or more instructions (e.g., multi-vector instructions) to perform an operation. The multi-vector instructions may refer to a class of instructions that operate on multiple data elements (or vectors) simultaneously to leverage parallel processing capabilities of the CPU. The multi-vector instructions may access multiple (e.g., 2 or 4) register file entries for a single operand.

The one or more instructions may be embedded with one or more source operands and a destination operand. The one or more source operands may include input data for the operation and the destination operand stores or receives a result of the operation.

The one or more instructions may specify architectural registers (e.g., which may be logical registers as used in an ISA). A reference to the architectural registers (e.g., in a vector) in the one or more instructions may be subject to the one or more restrictions.

For example, one restriction may restrict the architectural registers referenced in the vector in the one or more instructions to consecutive architectural registers. For example, any four consecutive architectural registers may be referenced (e.g., no wraparound from architectural registers 31 to 0 for the destination operand).

Another restriction may restrict the architectural registers referenced in the vector in the one or more instructions to architectural registers that are separate by a given stride corresponding to a fixed number of architectural registers. For example, four architectural registers, at every fourth architectural register, starting at architectural registers 0-3 or 16-19 may be referenced. For instance, architectural registers [0, 4, 8, 12] or architectural registers [19, 23, 27, 31] may be referenced. In another example, two architectural registers, at every eighth architectural register, starting at architectural registers 0-7 or 16-23 may be referenced. For instance, architectural registers [0, 8], [7, 15], or architectural registers [16, 24] may be referenced.

The register rename unit 400 of the CPU may manage renaming of the architectural registers specified by the one or more instructions during execution of the one or more instructions. The purpose of the renaming may be to avoid false dependencies, like write-after-write (WAW) or write-after-read (WAR) hazards, by providing a way to remap the architectural registers to physical registers (e.g., as used internally in the CPU) from multiple rename banks. A rename bank refers to a hardware structure used in a register renaming process. Each rename bank is a set of physical registers that are used to store values for the one or more instructions after the register renaming has occurred.

The register rename unit 400 may include control logic, freelists, and a register map table. The control logic may manage the freelists and the register map table. The freelists and the register map table are data structures that help manage allocation of the physical registers from the multiple rename banks to the one or more instructions for register renaming and track a mapping between the architectural registers and the physical registers.

In certain aspects, a freelist may be a data structure used to keep track of available (free) physical registers from the multiple rename banks that can be allocated to the one or more instructions for the register renaming. For example, when an instruction needs to write to a physical register, the control logic looks for a free physical register from the freelist. After allocation, this physical register is removed from the freelist and assigned to the instruction.

The freelists may be banked per physical register file bank. A single freelist may be used to allocate the physical registers to the instructions.

The freelist may be implemented as a queue or a stack. The freelist may hold indexes of free physical registers. In some cases, when a physical register is freed (for example, after the instruction has completed execution and its result has been written back), the physical register may be added back to the freelist, making the physical register available for future use. For example, there are physical registers P0, P1, P2, etc. Initially, the freelist may contain all these physical registers as available. When the instruction requires a physical register, one physical register is taken from the freelist (e.g., P0). Once the instruction finishes, P0 is returned to the freelist. In some cases, the physical register may not be returned to the freelist until a new instruction writing to a same architectural register is renamed and all reads to it are completed. A counter may be used to track whether all reads are completed or not.

In certain aspects, the control logic renames the architectural registers specified by the one or more instructions, to the physical registers that may be organized in the multiple rename banks, during execution of the one or more instructions. The control logic may acquire the physical registers that may be organized in the multiple rename banks from the freelist. The different rename banks correspond to different sets of physical registers.

The control logic may perform the renaming of the architectural registers specified by the one or more instructions using the register map table. For example, the register map table may be used to ensure that each of the architectural registers (e.g., which may be referenced by a single operand in the one or more instructions) are renamed to the physical registers in the different rename banks.

The register map table may be used to map adjacent architectural registers to the physical registers in the different rename banks. In some cases, the register map table may be used to map the architectural registers separated by a given stride length to the physical registers in a same rename bank.

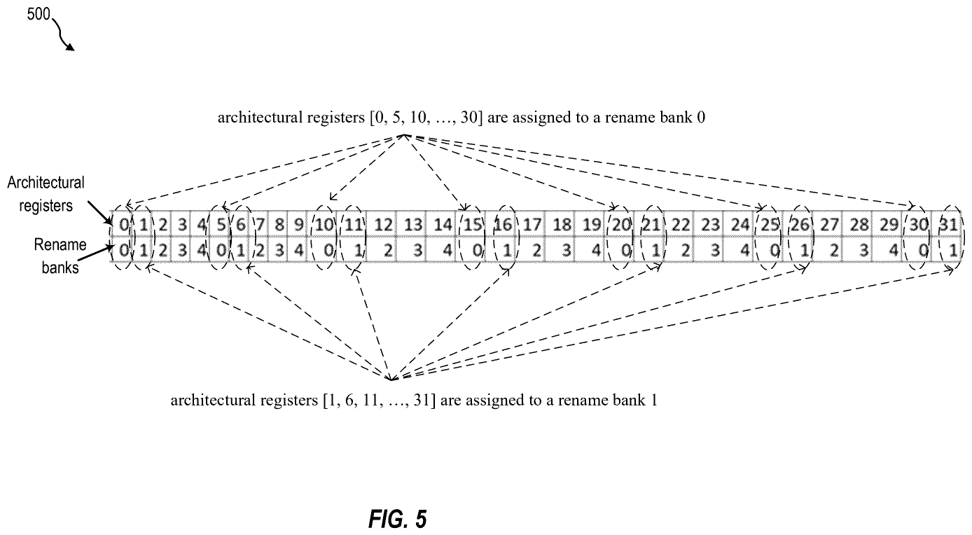

The mapping between the architectural registers to the physical registers that may be organized in the different rename banks is shown in FIG. 5. As shown, each architectural register will be renamed to a physical register from a different rename bank. That is, each architectural register is assigned to the different rename bank, as shown in a table 500 of FIG. 5. For example, architectural registers [0, 5, 10, . . . , 30] are assigned to a rename bank 0, architectural registers [1, 6, 11, . . . , 31] are assigned to a rename bank 1, and so on. Since there are restrictions (as noted above) on which architectural registers can be used in the vector in the one or more instructions, no vector will have more than one architectural register sent or assigned to a same rename bank.

In certain aspects, a rename bank may hold the physical registers that correspond to the architectural registers used in the one or more instructions. The physical registers are used for actual computation and data storage during execution. For example, when the one or more instructions are executed, the one or more instructions may refer to the architectural registers, but during the register renaming, the architectural registers may be mapped to a set of physical registers from the different rename banks. This allows the CPU to track results of the one or more instructions independently, even if the one or more instructions appear to be using a same architectural register. For example, when an instruction writes to a register, it doesn't necessarily write to the same physical register each time. Instead, the control logic may assign a new physical register from a different rename bank, which is linked to the architectural register used by the instruction.

Referring back to FIG. 4, a register map table is a table that tracks mapping between the architectural registers and the physical registers (e.g., which may be organized in the different rename banks). The register map table may help maintain a correspondence between the architectural registers and the physical registers (e.g., that are being used during execution).

The register map table may contain entries for each architectural register that the CPU needs to track. Each entry in the register map table points to a physical register (or possibly indicates that the architectural register is not yet allocated if the instruction hasn't executed yet).

The register map table may be a direct mapping from the architectural registers (e.g., R0, R1, R2 in the ISA) to the physical registers (e.g., P0, P1, P2 in the CPU) organized in the different rename banks. When the register renaming occurs, the register map table may be updated by the control logic to reflect the new physical register being used for the architectural register. For example, the ISA has an architectural register R1. If the control logic renames the architectural register R1 to a physical register P3, the register map table will have an entry mapping R1 to P3. This allows the control logic to know that any instruction that needs to read or write the architectural register R1 should actually access the physical register P3.

In some cases, single-vector and multi-vector operations may be mixed within an instruction sequence. In this case, it may happen that one rename bank may become heavily utilized while another rename bank remains empty. To address this, a physical bank to a rename bank mapping may be performed. As an example, assume there are N number of physical banks. Of these N number of physical banks, a subset of physical banks may be assigned to the rename banks at initialization. If one bank becomes full, it can be swapped for one of inactive banks.

For example, there may be 200 physical registers and each rename bank may have 40 physical registers. An instruction stream allocates many physical registers from rename bank 0. If there are multi-vector instructions, the multi-vector instructions may stall if there is a need to assign a physical register from rename bank 0 but none of physical registers from rename bank 0 are available. This leads to some performance inefficiency, as other 4 rename banks are mostly unused but still getting stalls. So, to address such issues, banks may be made more granular. For instance, there may be 10 physical banks of 20 physical registers, instead of 5 physical banks of 40 physical registers. Initially, physical banks 0-4 may be assigned to rename banks 0-4. When rename bank 0 becomes full, remap rename bank 0 to physical bank 5. This process gives more flexibility in avoiding the stall, and better utilization of all physical registers.

### Example Method

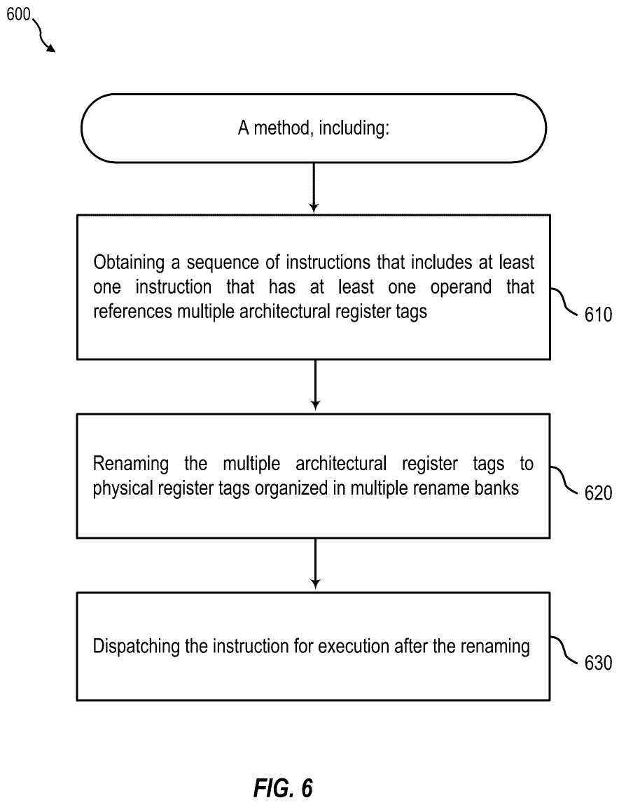

FIG. 6 depicts a method 600 for renaming architectural register tags to physical register tags organized in multiple rename banks.

The method 600 begins at 610 with obtaining a sequence of instructions that includes at least one instruction that has at least one operand that references multiple architectural register tags (e.g., which may also be referred to as architectural registers).

The method 600 at 620 includes renaming the multiple architectural register tags to physical register tags (e.g., which may also be referred to as physical registers) organized in multiple rename banks.

The method 600 at 630 includes dispatching the instruction for execution after the renaming.

In certain aspects, the renaming is performed using a mapping table that maps architectural register tags to physical register tags organized in multiple rename banks.

In certain aspects, the mapping table ensures each of the multiple architectural register tags referenced by a single operand are renamed to physical register tags in different register rename banks.

In certain aspects, the mapping table maps adjacent architectural register tags to physical register tags in different register rename banks.

In certain aspects, the mapping table may have a fixed assignment from architectural register tags to physical register tags according to a modulo function that may be applied based on an architectural register tag identifier (ID) or number.

In certain aspects, the mapping table maps architectural register tags separated by a given stride length to physical register tags in a same register rename bank.

The method 600 further includes tracking unused physical registers using a banked freelist.

In certain aspects, the reference to the multiple architectural register tags is subject to one or more restrictions.

In certain aspects, the one or more restrictions restrict the multiple architectural register tags referenced by a single operand to: consecutive architectural register tags; or architectural register tags that are separate by a given stride corresponding to a fixed number of architectural register tags.

In certain aspects, the at least one operand comprises a destination operand; and the instruction involves a vector operation that writes results to the multiple architectural register tags referenced by the operand.

In certain aspects, the at least one operand comprises a source operand; and the instruction involves a vector operation that writes results to the multiple architectural register tags referenced by the operand.

In certain aspects, the sequence of instructions also includes at least one least one instruction that has operands that each only reference a single architectural register tag.

Note that FIG. 6 is just one example of a method, and other methods including fewer, additional, or alternative steps are possible consistent with this disclosure.

### Example Clauses

Implementation examples are described in the following numbered clauses:
Clause 1: A method, comprising: obtaining a sequence of instructions that includes at least one instruction that has at least one operand that references multiple architectural register tags; renaming the multiple architectural register tags to physical register tags organized in multiple rename banks; and dispatching the instruction for execution after the renaming.
Clause 2: The method of clause 1, wherein the renaming is performed using a mapping table that maps architectural register tags to physical register tags organized in multiple rename banks.
Clause 3: The method of clause 2, wherein the mapping table ensures each of the multiple architectural register tags referenced by a single operand are renamed to physical register tags in different register rename banks.
Clause 4: The method of clause 3, wherein the mapping table maps adjacent architectural register tags to physical register tags in different register rename banks.
Clause 5: The method of clause 3, wherein the mapping table has a fixed assignment from architectural register tags to physical register tags according to a modulo function applied based on an architectural register tag identifier (ID) or number.
Clause 6: The method of any one of clauses 1-5, further comprising tracking unused physical registers using a banked freelist.
Clause 7: The method of any one of clauses 1-6, wherein the reference to the multiple architectural register tags is subject to one or more restrictions.
Clause 8: The method of clause 7, wherein the one or more restrictions restrict the multiple architectural register tags referenced by a single operand to: consecutive architectural register tags; or architectural register tags that are separate by a given stride corresponding to a fixed number of architectural register tags.
Clause 9: The method of any one of clauses 1-8, wherein: the at least one operand comprises a destination operand; and the instruction involves a vector operation that writes results to the multiple architectural register tags referenced by the operand.
Clause 10: The method of any one of clauses 1-9, wherein: the at least one operand comprises a source operand; and the instruction involves a vector operation that writes results to the multiple architectural register tags referenced by the operand.
Clause 11: The method of any one of clauses 1-10, wherein the sequence of instructions also includes at least one least one instruction that has operands that each only reference a single architectural register tag.
Clause 12: An apparatus, comprising: at least one memory comprising instructions; and one or more processors configured, individually or in any combination, to execute the instructions and cause the apparatus to perform a method in accordance with any one of Clauses 1-11.
Clause 13: An apparatus, comprising means for performing a method in accordance with any one of Clauses 1-11.
Clause 14: A non-transitory computer-readable medium comprising executable instructions that, when executed by one or more processors of an apparatus, cause the apparatus to perform a method in accordance with any one of Clauses 1-11.
Clause 15: A computer program product embodied on a computer-readable storage medium comprising code for performing a method in accordance with any one of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
receiving at least one instruction that references multiple architectural registers;
renaming the multiple architectural registers to physical registers organized in multiple rename banks; and
dispatching the instruction for execution after the renaming.

2. The method of claim 1, further comprising using a mapping table to map the multiple architectural registers to the physical registers for the renaming.

3. The method of claim 1, further comprising mapping each of the multiple architectural registers to a physical register in a different rename bank from the multiple rename banks for the renaming.

4. The method of claim 1, further comprising mapping adjacent architectural registers from the multiple architectural registers to the physical registers in different rename banks from the multiple rename banks for the renaming.

5. The method of claim 2, wherein the mapping table has a fixed assignment from architectural registers to physical registers according to a modulo function applied based on an architectural register tag identifier (ID) or number.

6. The method of claim 1, further comprising tracking unused physical registers using a banked freelist.

7. The method of claim 1, wherein:
the reference to the multiple architectural registers is subject to one or more restrictions, and
the one or more restrictions restrict the multiple architectural registers to:
consecutive architectural register; or
architectural registers that are separate by a given stride corresponding to a fixed number of architectural registers.

8. The method of claim 1, wherein:
the at least one instruction has at least one operand that references the multiple architectural registers;
the at least one operand comprises a destination operand; and
the at least one instruction involves a vector operation that writes results to the multiple architectural registers referenced by the destination operand.

9. The method of claim 1, wherein:
the at least one instruction has at least one operand that references the multiple architectural registers;
the at least one operand comprises a source operand; and
the at least one instruction involves a vector operation that writes results to the multiple architectural registers referenced by the source operand.

10. The method of claim 1, further comprising obtaining a sequence of instructions that includes an instruction that has operands that each only reference a single architectural register.

11. A method, comprising:
obtaining a sequence of instructions that includes at least one instruction that has at least one operand that references multiple architectural registers;
mapping the multiple architectural registers to physical registers organized in multiple rename banks, wherein each of the multiple architectural registers is mapped to a physical register in a different rename bank from the multiple rename banks; and
dispatching the at least one instruction for execution to at least one of a matrix processing unit (MXU) or a load store unit (LSU) after the mapping.

12. The method of claim 11, wherein at least one rename bank of the multiple rename banks refers to a set of physical registers configured to store values for one or more instructions.

13. The method of claim 11, further comprising:
determining a set of available physical registers from the multiple rename banks; and
allocating the physical registers from the set of available physical registers for the mapping.

14. The method of claim 11, further comprising at least one of:
tracking the mapping of the multiple architectural registers to the physical registers; or
adding the physical registers to a freelist after completion of the execution of the at least one instruction.

15. The method of claim 11, wherein:
the at least one operand comprises a destination operand; and
the at least one instruction involves a vector operation that writes results to the multiple architectural registers referenced by the destination operand.

16. The method of claim 11, wherein:
the at least one operand comprises a source operand; and
the at least one instruction involves a vector operation that writes results to the multiple architectural registers referenced by the source operand.

17. The method of claim 1, wherein:
the reference to the multiple architectural registers is subject to one or more restrictions, and
the one or more restrictions restrict the multiple architectural registers to consecutive architectural registers.

18. The method of claim 1, wherein:
the reference to the multiple architectural registers is subject to one or more restrictions, and
the one or more restrictions restrict the multiple architectural registers to architectural registers that are separate by a given stride corresponding to a fixed number of architectural registers.

19. An apparatus, comprising:
a memory comprising instructions; and
one or more processors, individually or collectively, configured to execute the instructions to cause the apparatus to:
receive at least one instruction that references multiple architectural registers;
rename the multiple architectural registers to physical registers organized in multiple rename banks; and
dispatch the instruction for execution after the renaming.

20. The apparatus of claim 19, wherein the one or more processors, individually or collectively, are configured to execute the instructions to cause the apparatus to map each of the multiple architectural registers to a physical register in a different rename bank from the multiple rename banks.
